(19) United States
(12) Patent Application Publication
(10) Pub. No.: US 2015/0285961 A1
(43) Pub. Date: Oct. 8, 2015

(54) ROD LENS ARRAY AND METHOD OF MANUFACTURING SAME

(71) Applicant: Mitsubishi Rayon Co., Ltd., Tokyo (JP)

(72) Inventors: Kazuyoshi KOIKE, Otake-shi (JP); Hiroshi Nakamura, Hatsukaichi-shi (JP)

(73) Assignee: Mitsubishi Rayon Co., Ltd., Tokyo (JP)

(21) Appl. No.: 14/245,327

(22) Filed: Apr. 4, 2014

(51) Int. Cl. G02B 3/00

(52) U.S. Cl. CPC G02B 3/0075; G02B 3/005; G02B 3/0025

(57) ABSTRACT

The present invention provides a rod lens array comprising a first board, a second board, and a plurality of rod lenses which are arranged in a row between the first and second boards. An outer surface of at least one of the first and second boards has a groove extending in a first direction. The first direction is along a longitudinal direction of the first and the second boards, and perpendicularly intersects a second direction in which the rod lenses extend. By engaging the groove of the rod lens array and projecting part of the housing of the CIS module, it becomes possible to easily arrange and fasten the rod lens array to a precise position in a CIS module.

### BACKGROUND OF THE INVENTION

1. Field of the Invention

The present invention generally relates to a rod lens array and a method of manufacturing the same. More particularly, the present invention relates a rod lens array, in which a plurality of rod lenses are arranged in a row between a first board and a second board, and a production method thereof.

2. Description of the Related Art

A rod lens array in which a plurality of rod lenses are arranged in a line between two boards is known in the art (for example, Japanese Patent Publication No. 5-303007A). Further, it is known to provide a groove in a board of the rod lens array and to use this groove to improve the mounting precision of the rod lens array to an optical apparatus (for example, Japanese Patent Publication No. 6-59101A).

As an application of such a rod lens array, there is use for a contact image sensor module (so-called “CIS module”) which is used for image scanners. When assembling the CIS module, the rod lens array is positioned at a predetermined position of the housing utilizing a step shape which is formed at the housing of the CIS module, and is fastened by a UV curing type adhesive and the like.

Mounting the rod lens array onto the CIS module requires a plurality of steps, applying the adhesive, positioning the rod lens array at a predetermined position, and curing the adhesive. Because a plurality of steps are required, it makes an assembling process of the CIS module complicated.

Furthermore, the rod lens array which constitutes a part of the optical system of a CIS module has to be accurately fastened by adhesive at the predetermined position in the CIS module. However, curing exotherm of the UV curable adhesive may cause the warpage of the rod lens array. It may cause the misalignment of the rod lens array from the predetermined position in the CIS module when curing the UV curable adhesive.

When positioning and fastening rod lens arrays in applications other than the CIS module, sometimes similar problem arose.

Further, to use the method which is described in the Japanese Patent Publication No. 6-59101A to improve the positioning precision of the rod lens array in the CIS module, it is necessary to precisely control the position of the cutting blade for forming a groove which has an accurate position and depth. However, such control of the cutting blade was not easy in a mass production process. For this reason, the art of forming a groove which has an accurate depth at an accurate position of a rod lens array by a simpler method has been sought.

### SUMMARY OF THE INVENTION

The present invention seeks to solve at least one of above identified problem, and is aimed to provide a rod lens array which can be accurately and easily attached to a CIS module. Furthermore the present invention is aimed to provide a rod lens array which is free from warping and displacement when fastening to the CIS module or other unit.

Furthermore, the present invention is aimed to provide a method of manufacturing the above mentioned rod lens array.

According to the preferred embodiment of the present invention, there is provided a rod lens array comprising a plurality of rod lenses which are arranged between a first board and a second board in a row, wherein at least one of outer surfaces of the first and second boards is provided with a groove which extends in a first direction perpendicularly intersecting a second direction in which the rod lenses extend.

In the preferred embodiment of the present invention, by combination with the housing of a CIS module and the like which is provided with a projecting part, the rod lens array is arranged at a predetermined position by engaging the projection part with the groove, whereby accurate and easy attachment to the CIS module and the like can be realized.

According to one aspect of the present invention, the groove extends across the entire length of at least one of the outer surfaces of the first and the second boards.

According to another aspect of the present invention, the rod lenses are exposed at a bottom of the groove. According to another preferred aspect of the present invention, the groove is provided at an approximate center of at least one of the outer surfaces of the first and the second boards in the second direction.

According to another aspect of the present invention, the groove has a width of 1/10 to ½ of the lengths of the rod lenses in the first direction. According to another aspect of the present invention, the groove has an approximately rectangular cross-section.

According to another aspect of the present invention, grooves are formed on the outer surfaces of the first and the second boards.

According to another preferred embodiment of the present invention, there is provided an optical apparatus provided with one of above described rod lens array, which comprises a lens holding part which is inserted into the groove to fasten the rod lens array.

According to one of the present invention, the lens holding part has a shape which is complementary with the groove.

According to another aspect of the present invention, the lens holding part has a width in the second direction which is smaller than the width of the groove, and in the state that the lens holding part is inserted into the groove, the rod lens array is slidable in the first direction.

According to another aspect of the present invention, the lens holding part has a width of 95% to less than 100% of the width of the groove in the second direction.

According to another preferred embodiment of the present invention, there is provided a method of manufacturing a rod lens array provided with a plurality of rod lenses which are arranged in a row between a first board and a second boards, comprising: a step of arranging a plurality of first board members which form the first board of the rod lens array at predetermined intervals in parallel; a step of arranging rod lenses in a row, wherein the each of the rod lenses has a length of extending across the first board members in a third direction which is perpendicular to the longitudinal directions of each of the first board members; a step of arranging a second board member which form the second board of the rod lens array; a step of providing a rod lens array plate by fastening the first board members, a plurality of rod lenses, and the second board member, wherein in the rod lens array plate, the plurality of rod lenses are arranged between the first board members and the second board member, and a part of rod lenses are exposed in the predetermined intervals between the first board members; and a step of cutting the rod lens array plate to cut the rod lens array plate into separated rod lens arrays.

According to another aspect of the present invention, the first and second board members are cut at the approximate centers in the first direction in the step of cutting first and second board members. According to another aspect of the present invention, in the step of arranging the second board member, a plurality of second board members having approximately same shape of the first board member are arranged at the predetermined intervals in parallel.

### BRIEF DESCRIPTION OF DRAWINGS

FIG. 1 is a schematic perspective view which shows the configuration of a rod lens according to the preferred embodiment of the present invention.

FIG. 2 is a schematic cross-sectional view which shows the state where a CIS module in which a rod lens array of a preferred embodiment of the present invention is assembled is assembled into a scanner.

FIG. 3 is a schematic perspective view of a rod lens array plate which is produced as an intermediate product by a method of manufacturing rod lens arrays of a preferred embodiment of the present invention.

FIG. 4 is a schematic perspective view of connected board members which are produced in the process of manufacturing the rod lens array plate of FIG. 3.

FIG. 5 is a schematic perspective view of connected board members of FIG. 4 to which the rod lenses are transferred.

FIG. 6 is a schematic perspective view which explains a step of cutting the rod lens array plate of FIG. 3.

FIG. 7 is a schematic perspective view of a rod lens array plate which is produced as an intermediate product by a method of manufacturing rod lens arrays of a preferred embodiment of the present invention.

FIG. 8 is a schematic perspective view which shows the configuration of a rod lens according to the preferred embodiment of the present invention.

### DESCRIPTION OF THE PREFERRED EMBODIMENTS

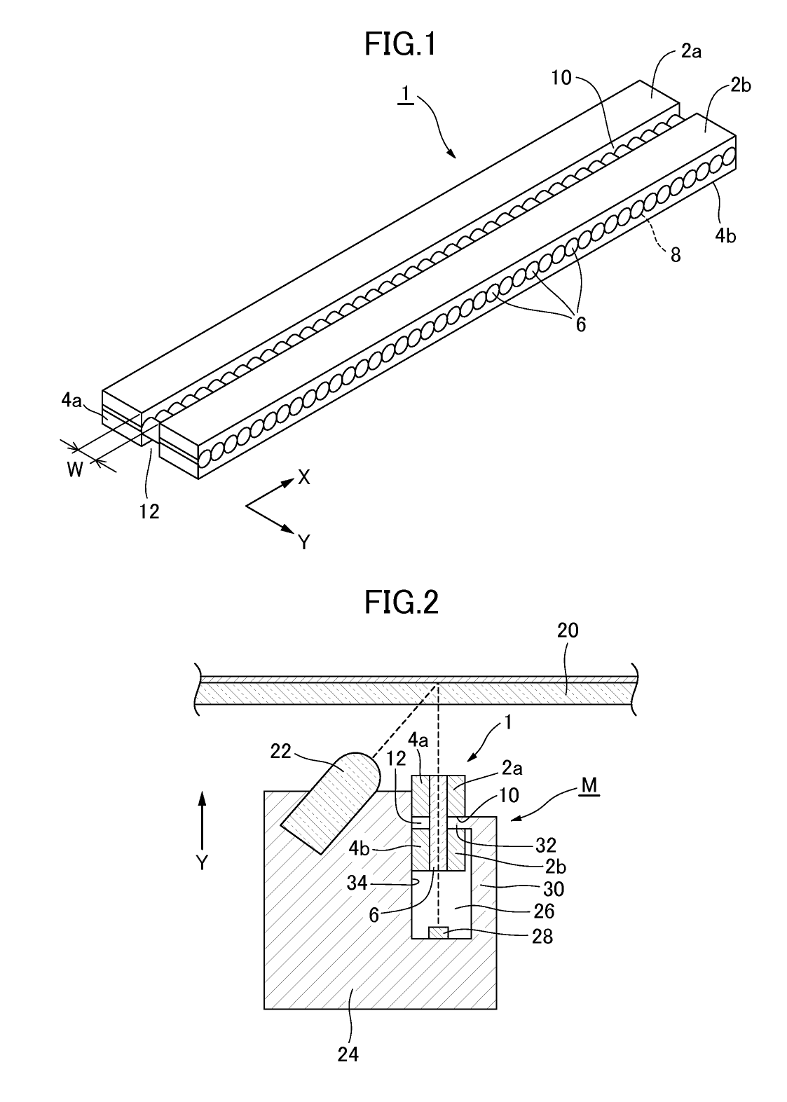

A rod lens array according to a preferred embodiment of the present invention will be explained with referring to FIG. 1. FIG. 1 is a schematic perspective view of a rod lens array 1.

In describing the structure of the rod lens array 1, the directions shown in FIG. 1 are used to explain the size and the width of components of the rod lens array 1.

First direction X: In a top view of the rod lens array 1 placed on the horizontal plane so that the rod lenses extend parallel with the horizontal plane, the first direction is along the longitudinal direction of the first and the second board, and perpendicularly intersects the direction in which the rod lenses are extending.

Second direction Y: In a top view of the rod lens array 1 placed on the horizontal plane so that the rod lenses extend parallel with the horizontal plane, the second direction perpendicularly intersects the longitudinal direction of the first and second boards, and is along the direction in which the rod lenses are extending.

In the FIG. 1, the rod lens array 1 is assembled in a CIS module and forms an integral part of the optical system of the CIS module. However, the rod lens array according to the present invention may be assembled into another unit besides a CIS module.

The rod lens array 1 of the present embodiment has a configuration similar to the conventional rod lens array in which a plurality of rod lenses are sandwiched between two boards. However, it differs from the conventional rod lens array in the following point. According to the preferred embodiment of the present invention, a plurality of rod lenses 6 are held between four elongated rectangular shaped boards 2a, 2b, 4a, and 4b.

In the present embodiment, the four boards 2a, 2b, 4a, and 4b have the approximately same dimensions and shapes. The boards 2a and 2b are arranged in parallel at a first side of the rod lens array 1 a predetermined interval W apart in the second direction, while the boards 4a and 4b are arranged facing the boards 2a and 2b in parallel at a second side of the rod lens array 1 a predetermined interval W apart in the second direction.

The rod lenses 6 have lengths of adding the boards 2a, 2b widths to W. Hence, as shown in FIG. 1, the rod lenses 6 are arranged between the boards 2a, 2b, 4a, and 4b so that their two end faces are aligned with the side end faces of the boards 2a, 2b, 4a, and 4b, and are fastened to the boards 2a, 2b, 4a, and 4b by an adhesive layer 8.

Due to such a configuration, in the rod lens array 1, as shown in FIG. 1, the first side outside surface which is formed by the boards 2a and 2b and the second side outside surface which is formed by the boards 4a and 4b are formed with, at the approximate centers in the width directions (in the second direction), positioning-use grooves 10 and 12 which have rectangular cross-sections of widths W and which extend in the first directions. In this specification, the cross section means a cross section by the vertical plane along the second direction of the rod lens array 1 placed on the horizontal plane. These grooves 10 and 12 extend in the first direction across the entire length of the rod lens array 1. In the following explanation, the board 2a and 2b together may be referred to as a first board 2 provided with the groove 10. As a same manner, the board 4a and 4b may be referred to as a second board 4 provided with the groove 12.

In the rod lens array 1, the grooves 10 and 12 have depths which are substantially equal to the thicknesses of the boards 2a, 2b, 4a, and 4b. At the bottom parts of the grooves 10 and 12, the rod lenses 6 are exposed.

Widths W of the grooves 10 and 12 are preferably from 1/10 to ½ of the lengths of the rod lenses 6 of the rod lens array 1 in the second direction. If the widths W are of sizes exceeding ½ of the lengths of the rod lenses 6, sometimes it becomes difficult to reliably hold the plurality of rod lenses 6. Furthermore, since the greater portion of the rod lenses 6 are exposed, light may leak from the rod lenses 6 and light leaked from the rod lenses 6 may incident into adjacent rod lenses 6 or on sensor of the CIS module. It may result in deteriorating the optical property of the rod lens array 1. If the widths W are smaller than 1/10 of the lengths of the rod lenses 6, it may become difficult to engage the grooves 10 and 12 with the positioning-use projecting parts in assembling the CIS module (describe later). For this reason, the above range is preferable.

Further, the four boards 2a, 2b, 4a, and 4b have the same dimensions and shapes (that is, the grooves 10 and 12 are positioned at the approximate centers of the rod lens array 1 in the second directions), so when assembling the rod lens array 1 into the later explained CIS module M, the CIS module M can be simply assembled without having to watch the up-down direction of the rod lens array 1.

FIG. 2 is a schematic cross-sectional view which shows the state where a CIS module M in which a rod lens array 1 of a preferred embodiment of the present invention is assembled is assembled into a scanner.

The CIS module M described in FIG. 2 is provided with an LED light source 22 which emits reading light toward a document bed 20 of a scanner and a housing 24 which supports a rod lens array 1.

The housing 24 is an elongated member which has a length substantially equal to the length of the rod lens array 1 in the first direction, that is, the reading width of the scanner (sub scan direction length). A cross-sectional rectangular recessed part 26 which has a slightly greater width than the thickness of the rod lens array 1 extends running through the length direction. At the bottom part of the recessed part 26, image reading-use sensors 28 are provided.

At the top end of a first side wall 30 which forms part of the recessed part 26, a projecting part 32 which extends toward the inside is formed. This projecting part 32 has a cross-sectional shape which is complementary with the cross-section of the groove 10 of the rod lens array 1. The projecting part 32 extends across the entire length of the housing 24 along the first direction of the rod lens array 1.

The projecting part 32 is fitted into the groove 10 (or the groove 12) of the rod lens array 1. Due to this configuration, the rod lens array 1 is clamped between the projecting part 32 of the housing 32 and the inside surface 34 of the second side wall which forms part of the recessed part 26, and is fastened to a predetermined position.

The CIS module M is configured so that if assembled into a scanner, the rod lens array 1 which is arranged at a predetermined position guides the light, emitted from the LED light source 22 and reflected by the document on the document bed 20, as shown by the broken line in FIG. 2, to the sensors 28 which are placed at the bottom part of the recessed part 26.

When assembling the rod lens array 1 into the CIS module M, firstly, the end part of the projecting part 32 is fitted into the groove 10. Secondly, the rod lens array 1 is slided with respect to the housing 24 along the first direction so that the rod lens array 1 is arranged in a predetermined position in the recessed part 26.

At this time, the projecting part 32 functions as a guide which guides the rod lens array 1, so the rod lens array 1 can slide along the projecting part 32 thereby it facilitate the positioning and fastening of the rod lens array 1 at a predetermined position in housing 24.

By setting the width of the groove 10 of the rod lens array 1 and the width of the projecting part 32 of the housing 24 (length in top-bottom direction in FIG. 2) to suitable values, it is possible to fasten the rod lens array 1 to a predetermined position of the housing 24 of the CIS module M without using an adhesive and the like.

The length of the projecting part 32 in the second direction (that is, the width of the projecting part 32) is preferably from 95% to less than 100% of the widths of the grooves 10 and 12. By setting the width of the projecting part 32 to such a range, it is possible to place the rod lens array 1 easily at a predetermined position for attachment to the housing 24 while preventing leakage of light from the rod lens array 1.

If the width of the projecting part 32 is less than 95% of the widths of the grooves, sometimes the positioning precision of the rod lens array 1 may deteriorate. Furthermore, light may leak from the rod lenses 6 and light leaked from the rod lenses 6 may incident into adjacent rod lenses 6 or on sensor of the CIS module. It may result in deteriorating the optical property of the CIS module M. If the width of the projecting part 32 is larger than 100% of the widths of the grooves 10 and 12, it becomes difficult to attach the rod lens array 1 to the housing 24. For this reason, the above range is preferable.

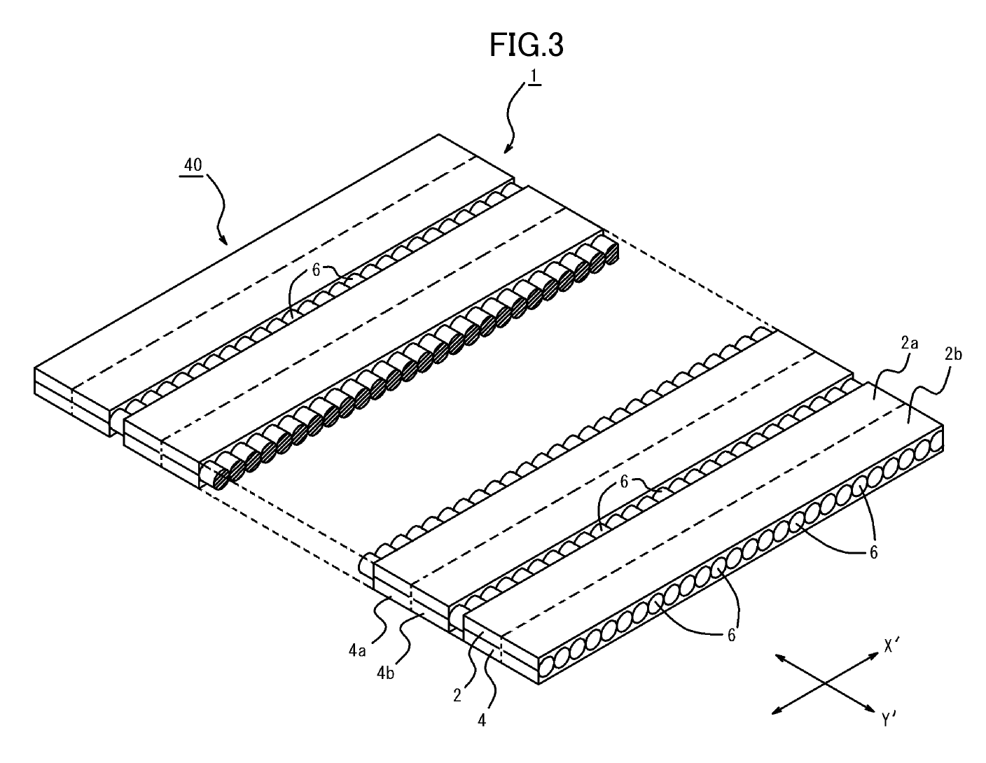

Next, a method of manufacturing rod lens arrays 1 of a preferred embodiment of the present invention will be explained. In the following description, the directions shown in FIG. 3 are used to explain the size and the width of components of the rod lens array plate 40.

Third direction Y′: In a top view of the rod lens array plate 40 placed on the horizontal plane so that the rod lenses extend parallel with the horizontal plane, the third direction is along the longitudinal direction of the first board members, and perpendicularly intersects the direction in which the rod lenses are extending.

Fourth direction X′: In a top view of the rod lens array plate 40 placed on the horizontal plane so that the rod lenses extend parallel with the horizontal plane, the fourth direction perpendicularly intersects the longitudinal direction of the first board members, and is along the direction in which the rod lenses are extending.

In the method according to the present embodiment, first, a rod lens array plate 40 (FIG. 3) is produced. A rod lens array plate 40 has first board members 2, second board members 4, and rod lenses 6 sandwiched between the first and second board members. The first and second board members are bonded together while sandwiching the rod lenses and are connected in a slatted manner. By cutting this rod lens array plate 40 at the center parts of the first and second board members 2 and 4 in the third directions along a dotted line shown in FIG. 3, then grinding or polishing the lens surfaces to mirror finishes, the rod lens arrays 1 described in FIG. 1 are obtained.

Next, method of manufacturing a rod lens array plate 40 will be described in detail.

In the present embodiment, a plurality of first board members 2 are used. The board members 2 are formed by the same materials as the boards 2a and 2b of the rod lens array 1. The width of first board member 2 in the third direction is equal to that of adding widths of the boards 2a and 2b. A plurality of positioning grooves 3 having U-shaped or V-shaped cross section are formed on the surfaces of the first board members 2. The grooves 3 are used for rod lens arrangement and are able to hold the rod lenses at predetermined positions.

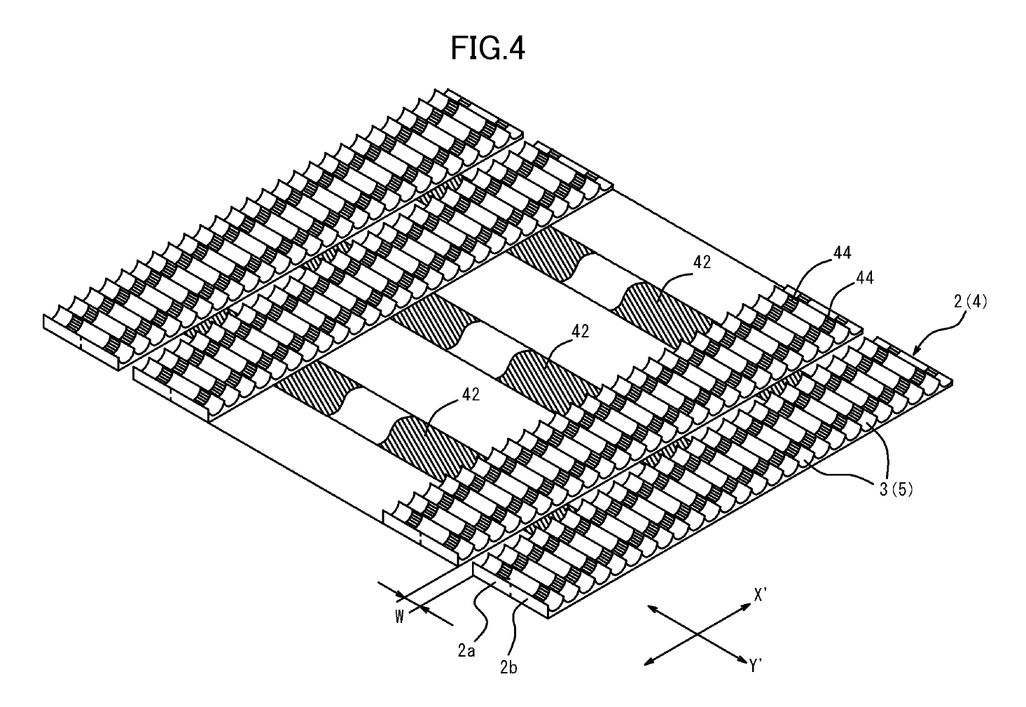

First, in a state that the positioning grooves 3 faces upward, a plurality of first board members 2 (for example, 13) are arranged in parallel at predetermined intervals, and are connected at their back surface sides by adhesive tape 42 in a slatted manner (FIG. 4). The predetermined intervals are set to values equal to the widths W of the grooves 10 and 12 of the rod lens arrays 1. As the adhesive tape 42, it is preferable to use a tape with little thermal expansion and easy to peel off even after being subjected to heat.

Adhesive 44 is applied on the surfaces of the first board members 2 having positioning grooves 3 by an adhesive coating system, and a first connected board members 46 is formed.

On the other hand, a provisional placement board having a plurality of grooves on its surface is prepared. The grooves of the provisional placement board have the same pitch as the positioning grooves 3 of the board members 2. Rod lenses 6 which have been cut to predetermined lengths (for example, 86 mm) are housed in all of the grooves so as to lay rod lenses 6 on the surface of the provisional placement board. The lengths of the rod lenses 6 are set to lengths which are substantially equal to the total widths of the first board members 2 arranged in parallel (that is, the length of the first connected board members 46 in the third direction). Further, the rod lenses 6 are laid across a width substantially equal to the length of the board members 2.

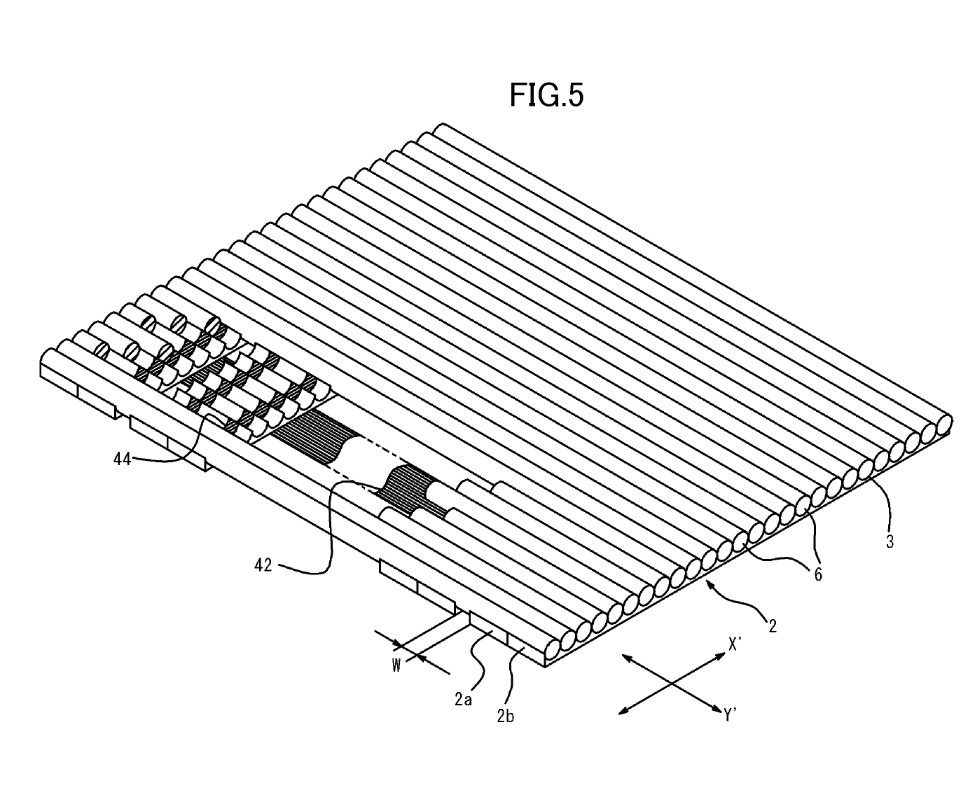

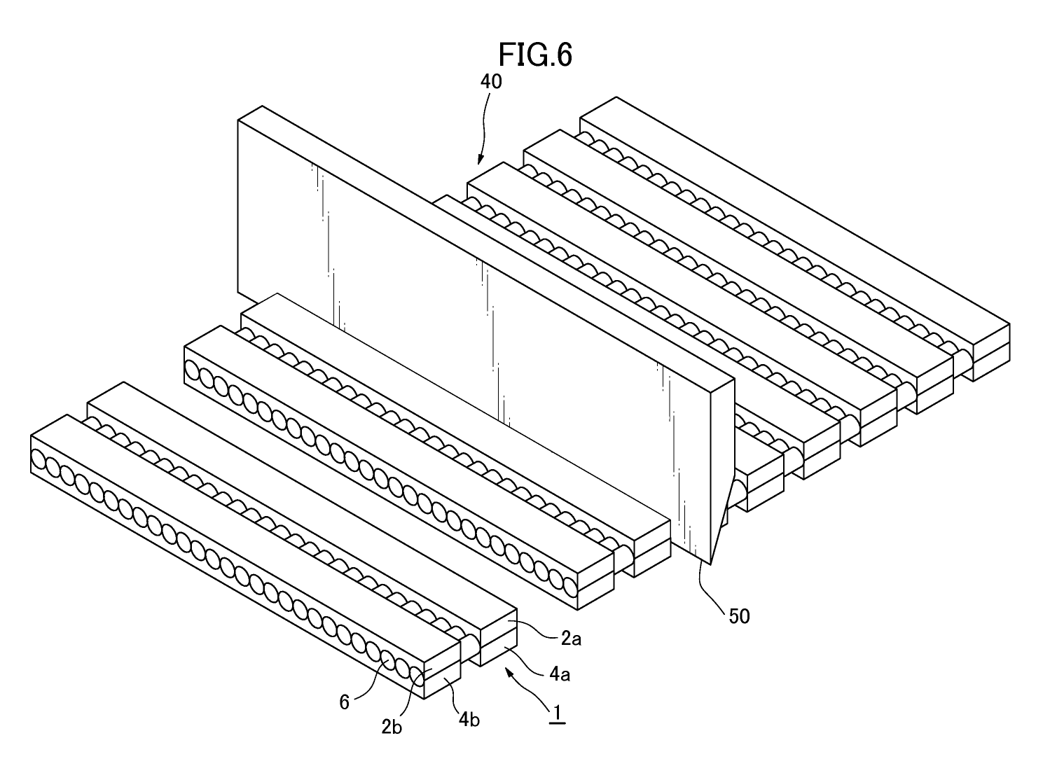

Next, the first connected board members 46 are arranged in a state with the adhesive coated surface facing downward and are brought into contact with the provisional placement board on which the rod lenses were laid from above in the vertical direction, so that the rod lenses 6 which were placed on the provisional placement board are transferred to the board members 2 which are connected in a slatted manner by the adhesive 44 (FIG. 5).

Furthermore, in the present embodiment, a plurality of second board members 4 are used. The board members 4 are formed by the same materials as the boards 4a and 4b. The width of have first board member 2 in the third direction is equal to that of adding widths of the boards 4a and 4b. A plurality of positioning grooves 5 having U-shaped or V-shaped cross section are formed on the surfaces of the second board members 4. The grooves 5 are used for rod lens arrangement and are able to hold the rod lenses at predetermined positions.

In a state that the positioning grooves 5 faces upward, a plurality of second board members 4 (for example, 13 members) are arranged in parallel at predetermined intervals, and are connected at their back surface sides by adhesive tape in a slatted manner. The predetermined intervals are set to values equal to the widths W of the grooves 10 and 12 of the rod lens arrays 1.

Adhesive 44 is applied on the surfaces of the second board members 4 having positioning grooves 5 by an adhesive coating system, and a second connected board members is formed. The second connected board member has a configuration similar to the first connected board members 46.

The first connected board members 46 to which the rod lenses 6 have been transferred to the surface is arranged in a state that the rod lenses facing upward, and the second connected board members with the adhesive coated surfaces facing downward are brought into contact with and pushed against the first connected board members 46 from above. At this time, the board members 2 of the first connected board members 46 and the board members 4 of the second connected board members are made to face each other, that is, are aligned. Due to this step, the second connected board members are bonded with the rod lenses 6 which are transferred to the first connected board members 46 whereby a rod lens array plate 40 (FIG. 3) is formed.

As explained above, in the first connected board members 46, the adjoining first board members 2 are separated by exactly distances which are equal to the widths W of the grooves 10 of the rod lens array 1. Thus, in the rod lens array plate 40, the first and second board members 2 and 4 bonded in top and bottom pairs are separated by distances equal to the widths W of the grooves 10 between the boards 2a and 2b. Next, the rod lens array plate 40 is removed from the production system and is press bonded by a hot press system.

The thus produced rod lens array plate 40 is placed in a cutting apparatus and cut by a cutting blade 50 of the cutting apparatus which operates by an up-down motion mechanism to obtain separated rod lens arrays 1. The rod lens array plate 40 is preferably cut at the center of the each of board member 2 in the third direction.

As explained above, the board members 2 and 4 which are bonded as top and bottom pairs in the rod lens array plate 40 are separated by distances exactly equal to the widths W of the grooves 10 between the boards 2a and 2b. Thus, by cutting the rod lens array plate 40 at the centers of the each of board members 2 and 4 in the third direction, rod lens arrays 1 as shown in FIG. 1, comprised of the boards 2a and 2b (4a and 4b) between which the groove 10 (12) of the width W is formed, are separated from the rod lens array plate 40. In such rod lens arrays 1, the grooves 10 and 12 are arranged at the approximate center positions of the rod lens arrays 1 in the second direction. Furthermore, the separated rod lens arrays 1 are polished or otherwise treated cut surface and become the final products of rod lens arrays 1.

Conventionally, due to the concern of light leakage, the positioning use grooves of the rod lens arrays have been provided as notches of end portion of the arrays or as a recessed part having depth not exposing the rod lenses on the outer surface of the array. To provide positioning-use grooves or recessed parts, an additional machining step of forming the grooves or recessed parts was necessary. To precisely form positioning-use grooves or recessed parts in the machining step, a precisely formed reference surface was necessary. Thus, after the surface of the rod lens array was precisely finished, the machine step has been performed to form grooves on the rod lens arrays. In the machining step, the depths and positions of the grooves have to be precisely controlled. However, sometimes additional machining step deformed the outer shape of the rod lens arrays.

In the method of manufacturing rod lens arrays according to the present embodiment, the spans between the separately arranged boards 2a and 2b are formed as grooves 10. For this reason, compared with the case of using post machining processing to form grooves on the boards, the grooves 10 can be more simply and accurately provided.

Furthermore, the widths W of the grooves 10 can be set at the stage of placing the boards members. For this reason, compared with forming the grooves on the boards by additional machining step, it becomes possible to control the widths of the grooves 10 more simply and precisely. Further, by arranging the boards apart from each other and cutting the boards at their substantial centers, it is possible to produce rod lens arrays 1 in which grooves 10 are formed without changing much at all the conventional production process of rod lens arrays 1.

Furthermore, by making projecting parts 32 of substantially the same shapes as the grooves 10 engage with them for positioning, it is possible to suppress leakage of light from the rod lens arrays 1 and is possible to more simply produce the optical systems of CIS modules etc.

The present invention is not limited to the above embodiments. Various changes and modifications are possible within the scope of matters which are described in the claims.

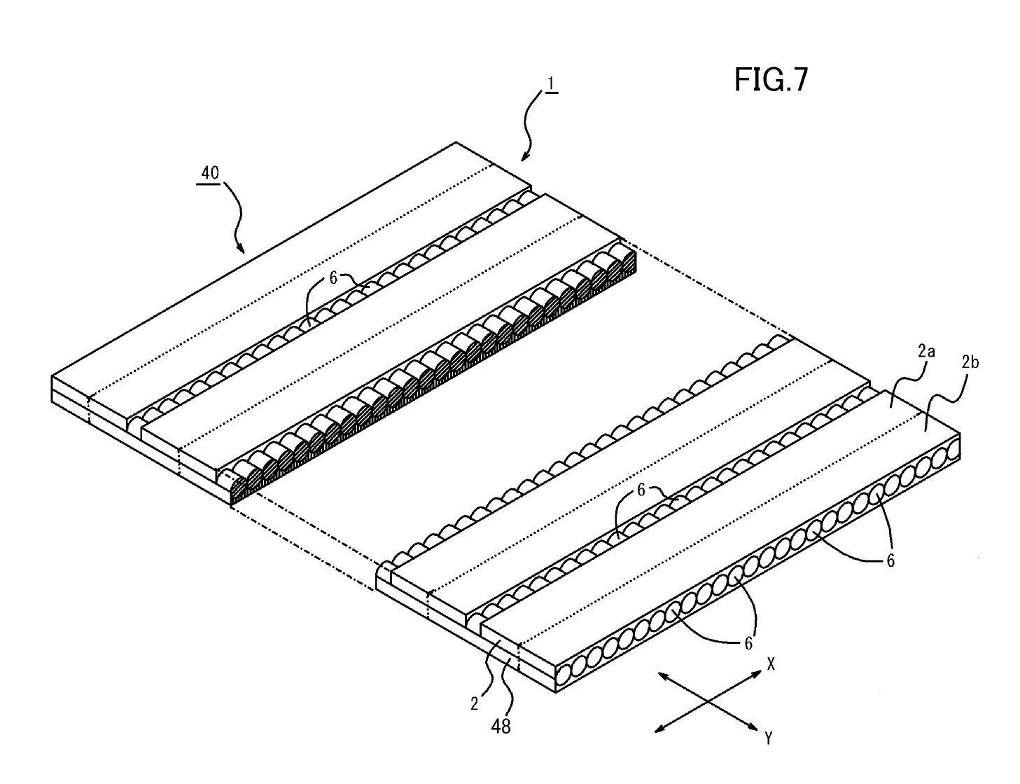

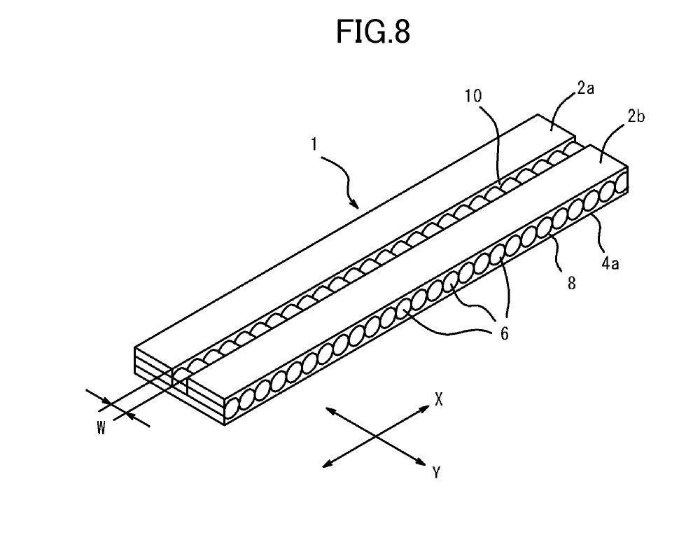

The rod lens array 1 of the present embodiment is comprised of two side boards 2a, 2b and 4a, 4b between which grooves 10 and 12 are formed, but a groove may also be formed just one of the sides. For example, as described in FIG. 7, by using the single large second board member 48 instead of plurality of board members, it is possible to simply produce a rod lens array having a groove on the one side surface (FIG. 8). Further, the positions of the grooves are not limited to the center of the rod lens array in the second direction. Furthermore, the cross-sectional shapes of the grooves may be shapes which are complementary with the projecting parts of the housing of the CIS module etc. and are not limited to rectangular shapes.

Further, in the method of the above embodiment, the rod lens array plate 40 was cut by a cutting blade which moved up and down, but another cutting method, for example, a rotary blade, may also be used to cut the board members 2 and 4 at the centers in their width directions. Further, the cutting positions are not limited to the centers of the board members in the width directions. It is sufficient that they be on the board members 2 and 4.

1. A rod lens array comprising:
a first board;
a second board; and
a plurality of rod lenses which are arranged in a row between the first and second boards,
wherein an outer surface of at least one of the first and second boards has a groove extending in a first direction, and
the first direction is along a longitudinal direction of the first and the second boards, and perpendicularly intersects a second direction in which the rod lenses extend.

2. The rod lens array according to claim 1, wherein the groove extends across the entire length of at least one of the outer surfaces of the first and second boards.

3. The rod lens array according to claim 1, wherein the rod lenses are exposed at a bottom of the groove.

4. The rod lens array according to claim 1, wherein the groove is provided at approximately center of at least one of the outer surfaces of the first and the second boards in the second direction.

5. The rod lens array according to claim 1, wherein the groove has a width of 1/10 to ½ of the lengths of the rod lenses in the second direction.

6. The rod lens array according to claim 1, wherein a cross-section of the groove along the second direction is an approximately rectangular shape.

7. The rod lens array according to claim 1, wherein grooves are formed on the outer surfaces of the first and the second boards.

8. An optical apparatus which is provided with a rod lens array according to claim 1, comprising a lens holding part which is inserted into the groove to fasten the rod lens array.

9. The optical apparatus according to claim 8, wherein the lens holding part has a shape which is complementary with the groove.

10. The optical apparatus according to claim 8, wherein the lens holding part has a width in the second direction which is smaller than the width of the groove, and in the state that the lens holding part is inserted into the groove, the rod lens array is slidable in the first direction.

11. The optical apparatus according to claim 10, wherein the lens holding part has a width of 95% to less than 100% of the width of said groove in the second direction.

12. A method of manufacturing a rod lens array provided with a plurality of rod lenses which are arranged in a row between a first board and a second boards, comprising:
a step of arranging a plurality of first board members which form the first board of the rod lens array at predetermined intervals in parallel;
a step of arranging rod lenses in a row, wherein the each of the rod lenses has a length of extending across the first board members in a third direction which is perpendicular to the longitudinal directions of each of the first board members;
a step of arranging a second board member which form the second board of the rod lens array;
a step of providing a rod lens array plate by fastening the first board members, a plurality of rod lenses, and the second board member,
wherein in the rod lens array plate, the plurality of rod lenses are arranged between the first board members and the second board member, and
a part of rod lenses are exposed in the predetermined intervals between the first board members; and
a step of cutting the rod lens array plate to cut the rod lens array plate into separated rod lens arrays.

13. The method of manufacturing a rod lens array according to claim 12, wherein the first board members are cut at the approximate centers in the first direction in the step of cutting first and second board members.

14. The method of manufacturing a rod lens array according to claim 12, wherein in the step of arranging the second board member, a plurality of second board members having approximately same shape of the first board member are arranged at the predetermined intervals in parallel.
